(19) United States
(12) Patent Application Publication
(10) Pub. No.: US 2020/0164838 A1
(43) Pub. Date: May 28, 2020

(54) HEATABLE FLUID CHAMBER ASSEMBLY AND METHOD OF MANUFACTURING SAME

(71) Applicant: A. RAYMOND ET CIE SCS, Grenoble (FR)

(72) Inventor: Karl BODE, Lörrach (DE)

(21) Appl. No.: 16/627,694

(22) PCT Filed: Jun. 25, 2018
(86) PCT No.: PCT/EP2018/066914

§ 371 Date: Dec. 30, 2019

(30) Foreign Application Priority Data
Jun. 30, 2017 (DE) 102017114607.5

(51) Int. Cl. B60S 1/48; F16L 53/38; B60S 1/52

(52) U.S. Cl. CPC B60S 1/488; B60S 1/481; F16L 53/38; F01N 2610/10; H05B 2203/021; F01N 2610/1486; B60S 1/52

(57) ABSTRACT

A heatable fluid chamber assembly for a window or headlight washer system of a vehicle is disclosed. The assembly comprises a fluid chamber having a first fluid port and a heating line, arranged in the fluid chamber and generally arranged in the first fluid port. A rotary disk is arranged rotatably about an axis in or on the fluid chamber. A deflector extends into the fluid chamber. A portion of the heating line is deflectable by the deflector during a rotation of the rotary disc. A method of manufacturing the heatable fluid chamber assembly is also disclosed. The method comprises providing the fluid chamber having the first fluid port and passing the heating line through the first fluid port into the fluid chamber. A portion of the heating line is deflected by rotating the rotary disk which is arranged rotatably about the axis in or on the fluid chamber.

### CROSS-REFERENCE TO RELATED APPLICATIONS

This application is the National Stage of International Application No. PCT/EP2018/066914, filed on 25 Jun. 2018, which claims priority to and all advantages of German Patent Application No. 102017114607.5, filed on 30 Jun. 2017, the content of which is hereby incorporated by reference.

### FIELD OF THE INVENTION

The subject invention generally relates to a heatable fluid chamber assembly and to a method for its manufacture.

### BACKGROUND OF THE INVENTION

Heatable fluid chamber assemblies are known from practice. Such heatable fluid chamber assemblies may be provided in window or headlamp washing systems of motor vehicles in order to prevent the washing fluid from freezing or to melt ice already formed. For example, EP 2 078 647 A2 discloses a vehicle window and/or headlight washing system comprising a nozzle heated by a heating cable. The heating cable should be laid in the nozzle in the form of a meander.

While a meander-shaped arrangement of the heating cable improves the heating capacity in the nozzle, the meander-shaped laying is technically difficult to realize in production. It is therefore an object of this disclosure to provide a heatable fluid chamber assembly which, through simple adaptations, improves the heating performance and at the same time allows for simple production.

### SUMMARY OF THE INVENTION

A heatable fluid chamber assembly is provided. A method of manufacturing a heatable fluid chamber assembly is also provided.

The heatable fluid chamber assembly for a window or headlight washing system of a vehicle according to this disclosure comprises a fluid chamber with a first fluid port and a heating line which is arranged in the fluid chamber and generally in the first fluid port. A rotary disk is rotatably arranged on or in the fluid chamber about an axis and has a displacement element which extends into the fluid chamber, wherein a portion of the heating line is displaceable by the deflector during rotation of the rotary disk. The first fluid port extends radially to the axis. By shifting by turning the rotary disk, the heating line can be given a desired shape or course. Turning can be done much easier than, for example, manually laying a heating cable in the form of a meander as known from the state of the art. A displacement element, which may be synonymously referred to as a deflector, may be, for example, a projection, a cam or a pin, generally extending from the rotary disk into the fluid chamber and having an opening and/or a channel extending through it.

It may be advantageous if the fluid chamber does not have any projecting structure mounted or fixed to the center of its inside around which the heating line could laid or wrapped. In various embodiments, there is no such structure mounted or fixed anywhere on the inside of the fluid chamber.

In another embodiment, a second fluid port is provided at the fluid chamber. The heating line can run through the second fluid port. This can be advantageous, for example, in window or headlamp washing systems where several heatable fluid chamber assemblies are provided. In this way, the heating line can run successively through several fluid chamber assemblies.

In various embodiments, the deflector in a first rotary position of the rotary disk can allow a substantially straight line of the heating line from the first fluid port to the second fluid port and through the fluid chamber. This allows the heating line to be guided through the finished fluid chamber assembly. This can support a simplification of production. It is also conceivable that the deflector is designed in such a way that a section of the heating line can already be displaced in and/or through the fluid chamber, e.g. in the direction of the axis. Advantageously, such displacement can be ensured through the aforementioned channel, which can extend through the deflector, for example by placing the channel in the first rotary position at an angle greater than 0° to the first and/or second fluid port. This is particularly useful if the first and second fluid ports are not collinear and/or if the first and/or second fluid ports are not radial to the axis.

For example, in cases where only a first fluid port is provided, it is conceivable that the deflector in a first rotary position of the rotary disk permits a substantially straight line of the heating line into the fluid chamber. Even in cases where only a first fluid port is provided, the deflector can be designed in such a way that a section of the heating line can already be displaced when it is inserted into the fluid chamber, e.g. in the direction of the axis. Advantageously, such displacement can be ensured through the aforementioned channel, which can extend through the deflector, for example by the channel being arranged at an angle greater than 0° to the first fluid port in the first rotational position.

In a further embodiment, a nozzle device and/or a check valve can be provided in the fluid chamber. These components can ensure a function of the fluid chamber assembly as a nozzle, e.g. in a window or headlight washing system of a vehicle. It may therefore be particularly desirable to place the section of the heating line near the nozzle device and/or the check valve, in particular to keep these components ice-free.

It may be advantageous if the rotary disk has a second deflector in addition to the deflector, which extends into the fluid chamber and is generally arranged eccentrically on the rotary disk with respect to the axis. This can simplify and/or improve the relocation of the section of the heating line. It may be particularly advantageous if the second deflector is located on a side of the heating line opposite the deflector. It can also be advantageous if the heating line runs between the deflector and the second deflector. Such configurations can make it possible to specifically influence the direction and/or extent of the displacement.

It is conceivable that the deflector is arranged in a second rotary position in the area of the nozzle device and/or the check valve. In this way it can be achieved that the heating line is also brought into the area of the nozzle device and/or the check valve with the deflector. As a result, the heat input can also be directed in this direction.

It is also conceivable that the deflector has a pressing surface which presses the heating line against the nozzle device and/or against the check valve when the rotary disk is rotated. This ensures a particularly efficient heat transfer.

In another embodiment, a transition area between the fluid chamber and the first fluid port and/or a transition area between the fluid chamber and the second fluid port may have a heat protector. This can be advantageous in situations where the heating line comes into contact with or near the respective transition areas due to the relocation. This prevents heat damage or even leaks at the transition areas.

In a further embodiment, the heating line can run in a displaced state in a plane that is linearly independent of a direction vector of the axis, the direction vector generally running perpendicular to the plane. The fact that the plane is linear independent of the direction vector of the axis can mean that the plane is spanned by two vectors and these vectors and the direction vector of the axis are linear independent of each other.

It can be advantageous if the first fluid port and the second fluid port are collinear to each other. In general, both the first and the second fluid port extend radially to the axis. Collinear fluid ports enable particularly easy guiding of the heating line through both fluid ports and the fluid chamber. If these run additionally radially to the axis, displacement can also be facilitated by turning the rotary disk.

Furthermore, it can be advantageous if the section of the heating line can be displaced by the rotation of the rotary disk in a direction that is essentially parallel to the axis. Such a further embodiment of displacement allows the heating line to be positioned even more flexibly in the fluid chamber.

It may be particularly advantageous if the section of the heating line can be displaced in three dimensions by rotating the rotary disk. It may be also particularly advantageous if the deflector is configured for winding up the heating line. In this way, an especially long section of the heating line can be arranged in the fluid chamber in a particularly space-saving manner.

This disclosure also provides a window or headlamp washing system for a vehicle, which includes a fluid chamber assembly of the type described above. Furthermore, this disclosure provides a vehicle which includes such a window or headlamp washing system.

This disclosure also provides a method of manufacturing a heatable fluid chamber assembly for a window or headlight washing system of a vehicle. This comprises the following method steps: Providing a fluid chamber with a first fluid port and guiding a heating line through the first fluid port into the fluid chamber. The method includes displacing a section of the heating line by rotating a rotary disk arranged on or in the fluid chamber to be rotatable about an axis. Displacing the heating line through the rotary disk can make it easier to guide the heating line through the fluid chamber and the first fluid port compared to the state of the art, since in the latter, a meander-shaped course of the heating line must already be created while it is being guided through the fluid chamber.

In one embodiment, a section of the heating line can be moved into and/or through the fluid chamber while it is being guided. As already described above, this can be ensured by a channel in a deflector of the rotary disk. The relevant explanations with reference to the fluid chamber assembly according to the disclosure also apply accordingly to the method according to the disclosure for their production.

The fluid chamber can have a second fluid port here as well. It is conceivable that the method may also include guiding the heating line through the fluid chamber and generally through the second fluid port.

The fluid chamber can have a nozzle device and/or a check valve. It may be advantageous if the method involves displacing the section of the heating line towards a nozzle device and/or a check valve. In this way, the heat input can be concentrated specifically on these components, which in some designs can be particularly susceptible to ice formation.

In a further embodiment, displacing the section of the heating line can cause the section to come into contact with the nozzle device and/or the check valve. This can further improve heat transfer.

It may be advantageous if a deflector arranged on the rotary disk is brought into engagement with the heating line by turning the rotary disk. A displacement element, which can also be called a deflector, can e.g. be a projection, a cam or a pin with an opening, which generally extends from the rotary disk into the fluid chamber.

It may be particularly advantageous if several, generally two (or more), deflectors arranged on the rotary disk are brought into engagement with the heating line by rotating the rotary disk. The deflectors can generally be brought into engagement with the heating line from at least two opposite sides of the heating line. In this way, the displacement of the heating line can be influenced even more specifically.

In a further embodiment, the method may include rotating the rotary disk by an angle greater than 180°, optionally greater than 360°. Furthermore, the method may include winding the heating line around the deflector. These embodiments may allow for a particularly space-saving arrangement of an especially long section of the heating line within the fluid chamber.

It is conceivable that the method involves displacing the section of the heating line in a direction that is essentially parallel to the axis. In addition, it is conceivable that the heating line section could be displaced in three dimensions. This creates flexibility options that enable a further increase in the number of arrangement variations for the heating line.

This disclosure relates to fluid chamber assemblies of the type described above, window or headlamp washing systems for a vehicle comprising them and vehicles equipped with such a window and headlamp washing system. Furthermore, the disclosure refers to methods for the manufacture of such fluid chamber assemblies. Advantageous embodiments are explained in more detail below using drawings.

### BRIEF DESCRIPTION OF THE DRAWINGS

The invention is described in greater detail below with reference to the accompanying figures, in which:

FIG. 1 shows an exploded representation of the components of an inventive fluid chamber assembly in perspective view.

FIG. 2 shows a sectional view of the assembled fluid chamber assembly in the perspective indicated in FIG. 1 with the sectional line A-A. A heating line is inserted into the fluid chamber through a first fluid port.

FIG. 3 shows the view from FIG. 2, but here the heating line is guided through the fluid chamber and through a second fluid port. The rotary disk has been turned clockwise.

FIG. 4 shows the view from FIGS. 2 and 3. In comparison to FIG. 3, the rotary disk has been turned further clockwise, which displaced the heating line.

FIG. 5 shows the view from FIGS. 2 to 4. The rotary disk has been turned so far that the heating line is arranged in the area of a nozzle device and in the area of a check valve.

FIGS. 6a to 6d show perspective views of the fluid chamber assembly at different stages of the manufacturing process.

FIGS. 7a and 7b show another embodiment of a deflector.

FIG. 8 shows a schematic plan view of an alternative fluid chamber assembly with a deflector from FIGS. 7a and 7b.

FIG. 9 shows a schematic, perspective view of a deflector from FIGS. 7a and 7b in an alternative second rotary position.

FIG. 10 shows a schematic sectional view of a deflector according to another embodiment.

### DETAILED DESCRIPTION

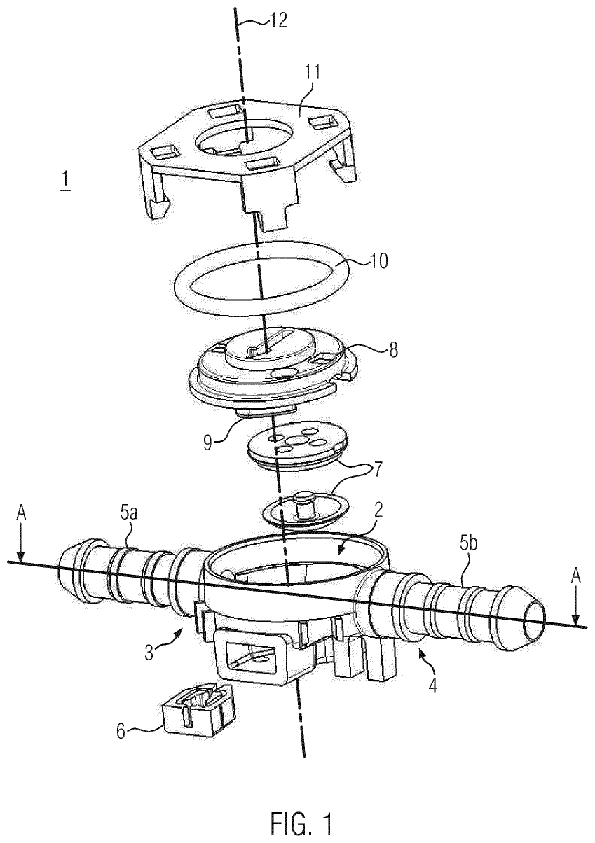

Referring to FIGS. 1-10, wherein like numerals indicate corresponding parts throughout the several views, a fluid chamber assembly is illustrated and generally designated 1. In particular, in accordance with certain embodiments, FIG. 1 shows components of the fluid chamber assembly 1 in exploded view. The fluid chamber assembly 1 comprises a fluid chamber 2, which in this embodiment is cylindrically shaped. However, it can have any suitable shape. A first fluid port 3 and a second fluid port 4 are provided at the fluid chamber. However, fluid chambers 2 or fluid chamber assemblies 1 with only one, first fluid port 3 are also conceivable. In this embodiment, the first and second fluid ports 3, 4 each have a connection device 5a, 5b. However, fluid ports 3, 4 may take any suitable shape suitable for introducing fluid into fluid chamber 2. Simple inlet openings are also conceivable. In this embodiment, the fluid chamber arrangement 1 has a nozzle device 6 and a check valve 7. However, this disclosure also covers fluid chamber assemblies 1 which have a nozzle device 6, which have a check valve 7 or which have neither of the two components.

The fluid chamber assembly 1 also includes a rotary disk 8. This rotary disk comprises a deflector 9. In this embodiment, the deflector 9 is embodied as projection 9. In this embodiment, the fluid chamber assembly 1 has a seal 10 and a fastening element 11. In this embodiment, the seal 10 and the fastening element 11 are used to arrange the rotary disk 8 rotatably on the fluid chamber 2. However, any other suitable way of attaching the rotary disk 8 to the fluid chamber 2 is also conceivable. The rotary disk 8 can be rotated about an axis 12. The rotary disk 8 may in particular be rotationally symmetrical to axis 12. If, as in the embodiment, a cylindrical fluid chamber 2 is provided, this can also be rotationally symmetrical to axis 12.

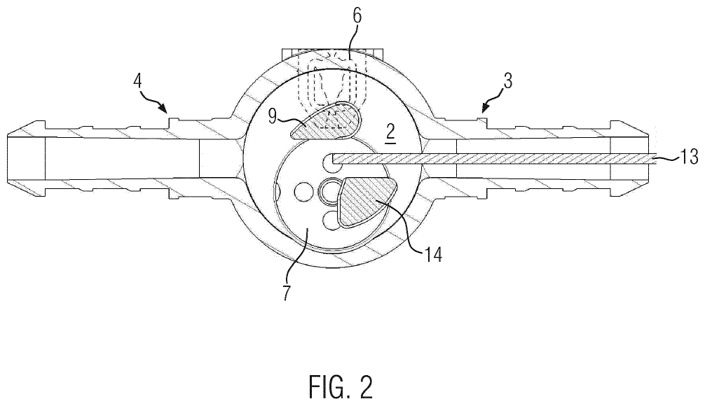

The line A-A in FIG. 1 indicates a sectional plane. It passes through the fluid ports 3, 4 and the fluid chamber 2, runs below the rotary disk 8 and intersects the deflector 9; a sectional view from the perspective of the arrows is shown in FIG. 2.

Since the sectional plane runs below the rotary disk 8, the latter cannot be seen in FIG. 2. It can be seen, however, that in FIG. 2 a heating line 13 was guided through the first fluid port 3 and into the fluid chamber 2. Furthermore, a second deflector 14 can be seen, which also extends from the rotary disk 8 into the fluid chamber 2. FIG. 2 shows a configuration in which the rotary disk 8 is arranged in a first rotary position. In the first rotary position, the deflector 9 is arranged in such a way that the heating line 13 can run in a straight line through the fluid chamber 2. In the present embodiment, the second deflector 14 is also arranged in such a way that the heating line 13 can run in a straight line through the fluid chamber 2. In particular, the heating line can run straight from the first fluid port 3 through the fluid chamber 2 to the second fluid port 4.

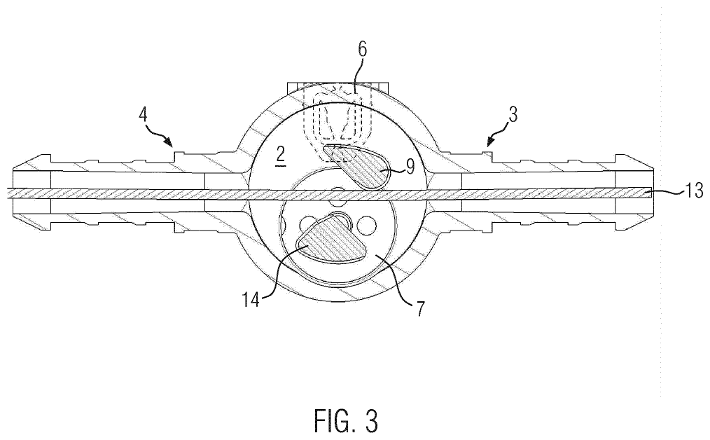

FIG. 3 shows the view from FIG. 2. In this view, heating line 13 was also guided through the second fluid port 4, so that it now runs through the first and second fluid ports 3, 4 and the fluid chamber 2. In addition, the rotary disk 8 was rotated about axis 12. The direction of rotation is clockwise in the view of FIG. 3. However, it is also conceivable that the direction of rotation is counterclockwise. In any case, the rotary disk is rotated in the direction towards a second rotary position, which will be explained in more detail later.

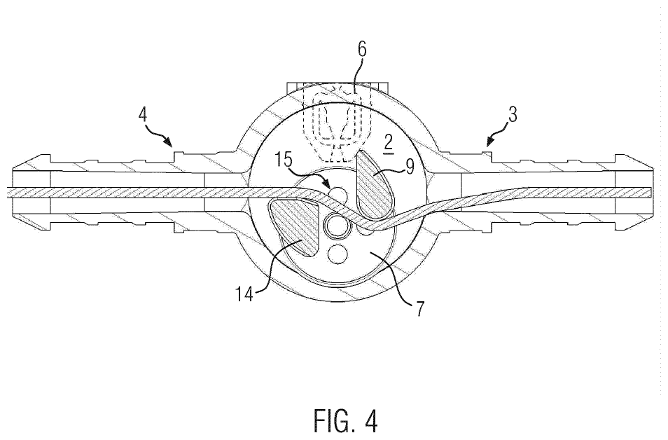

FIG. 4 shows the view from FIGS. 2 and 3. A configuration is shown in which the rotary disk 8 was rotated further towards the second rotary position, in this embodiment clockwise. The deflector 9 and the second deflector 14 are in engagement with the heating line 13 and it can be seen that a section 15 of the heating line 13 has been displaced by engagement with the deflector 9 and the second deflector 14.

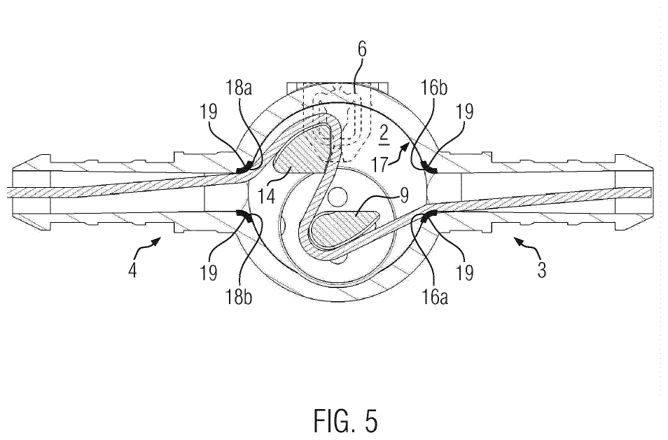

FIG. 5 shows the view from FIGS. 2 to 4. In the configuration shown, the rotary disk 8 was rotated further and is now in the second rotary position in the view shown in FIG. 5. In the second rotary position, the deflector 9 is located in the area of the check valve 7. The second deflector 14 is located in the area of the nozzle device 6. In embodiments where only the deflector 9 is provided, it may also be provided that the deflector 9 is located in the second rotary position of the rotary disk 8 in the area of the nozzle device 6.

FIG. 5 shows that in the present embodiment, through the engagement with the deflector 9, the heating line 13 also runs in the area of the check valve. Through the arrangement of the second deflector 14, the heating line 13 runs in the area of the nozzle device 7. Due to the displacement of the heating line 13 it contacts an inner wall 17 of the fluid chamber 2 at a transition area 16a between the first fluid port and the fluid chamber 2. At a transition area 18a between the second fluid port 4 and the fluid chamber 2, the heating line 13 also contacts the inner wall 17 of the fluid chamber 2. To avoid possible heat damage or leaks of the fluid chamber 2, a heat protector 19 can be provided at one or more of these transition areas 16a, 18a. This may, for example, have a metal plate or similar. Heat protector 19 may also be provided at other transition areas 16b, 18b.

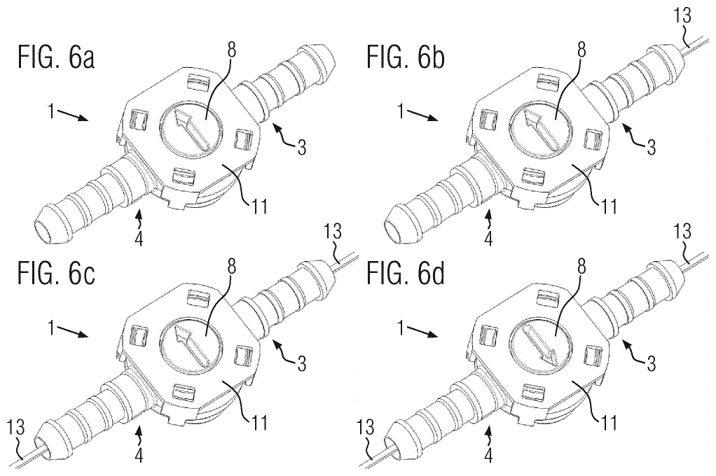

FIGS. 6a and 6b show a perspective view of a partially assembled fluid chamber assembly 2 in different stages of assembly. FIG. 6a shows the fluid chamber assembly 2 without the heating line 13 and the rotary disk 8 is in the first rotary position. In FIG. 6b, heating line 13 was inserted into the first fluid port 3. The rotary disk 8 is in the first rotary position. This configuration corresponds to the configuration shown in FIG. 2.

In FIG. 6c, heating line 13 was guided through fluid chamber 2 and through the second fluid port 4. The rotary disk 8 is still in the first rotary position.

In FIG. 6d, the rotary disk 8 was rotated by 180°. This configuration corresponds to the configuration shown in FIG. 5.

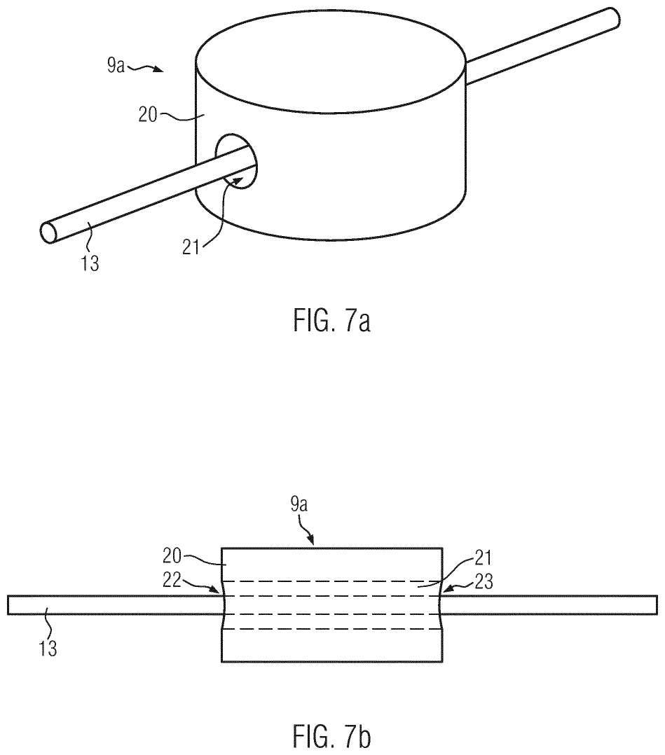

FIG. 7a shows another type of deflector 9, which is marked 9a for better clarity. Deflector 9a has a projection of 20 and a channel 21 is provided in projection 20. The heating line 13 runs through the channel 21. The deflector 9a is provided on the rotary disk 8 in such a way that in the first rotary position of the rotary disk 8, the channel 21 is aligned with the fluid ports 3, 4, i.e. that a straight line between the first fluid port 3 and the second fluid port 4 can pass through the channel.

In the second rotary position of the rotary disk 8, channel 21 can be arranged in such a way that a first opening 22 (see FIG. 7b) is arranged in the area of the nozzle device 6. It may also be provided that the first opening 22 of channel 21 is located in the second rotary position of the rotary disk in the area of the check valve 7. It is also conceivable that the first opening 22 of channel 21 is arranged in the second rotary position of the rotary disk 8 in the area of the nozzle device 6 and a second opening 23 (see FIG. 7b) of channel 21 is arranged in the area of the check valve 7 or vice versa.

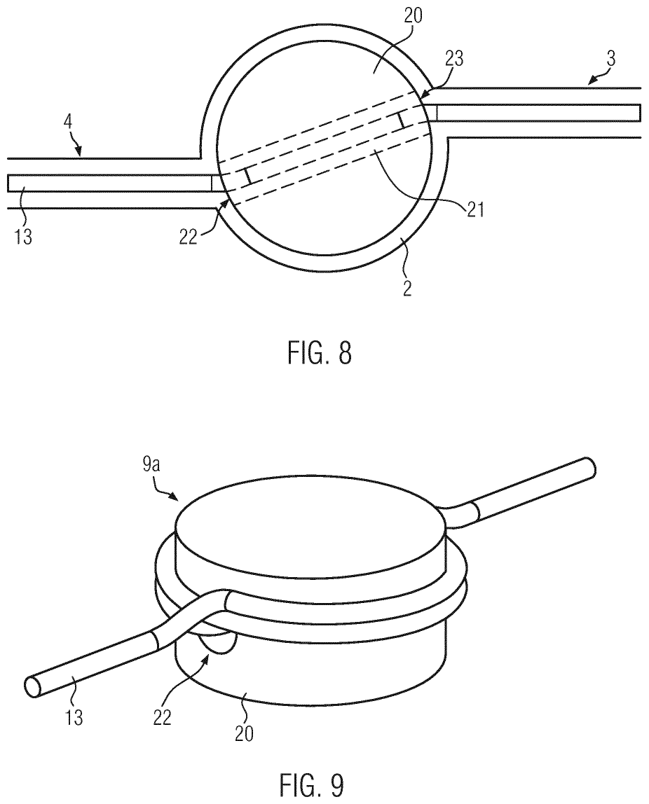

FIG. 8 shows a fluid chamber assembly 1a whose fluid ports 3, 4 are offset, i.e. in this case the fluid ports 3, 4 are not arranged collinear to each other and radial to axis 12 as in the previous embodiment. Similar to the previous embodiment, the channel 21 is aligned with the fluid ports 3, 4 in the first rotary position. In this case, however, it follows from the offset arrangement of fluid ports 3, 4 that channel 21 is arranged at an angle greater than 0° to the fluid ports 3, 4. In this way, a section of the heating line 13 can be moved when it is inserted into the fluid chamber 2. Such a displacement when inserting the heating line 13 can also be advantageous in other configurations of fluid chamber assembly 1, 1a, e.g. if only one of the fluid ports 3, 4 is not arranged collinear to the other and/or not radially to axis 12, or if only one fluid port 3, 4 is provided.

The perspective view shown in FIG. 8 shows a deflector 9a in an alternative second rotary position. In this example, it is rotated 360° from the first rotary position. The extent of this rotation is given as an example for any size of rotation greater than 45°. As the rotation increases, the section of heating line 13 located in fluid chamber 2 increases. This allows the heating power introduced into the fluid chamber 2 to be increased. It can also be seen that the heating line 13 has been moved in three dimensions.

The effects described with reference to FIG. 8 can be achieved by a deflector 9a as described with reference to FIGS. 7a, 7b and 8. However, it is also possible to achieve all or some of these effects by any deflectors described in the present application, in particular by combining a deflector 9 with a second deflector 14, as described with reference to FIGS. 2 to 5.

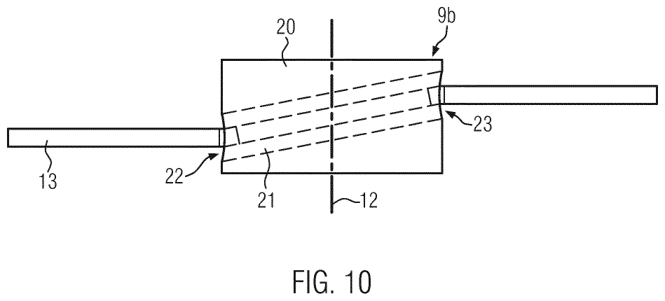

FIG. 10 shows another example of a deflector 9b in a schematic sectional view. The deflector 9b of FIG. 10, like the deflector 9a described above with reference to FIGS. 7 to 9, has a channel 21 extending through the deflector 9b. However, it is arranged at an angle to axis 12 which is greater or less than 90°, i.e. not 90°. In this embodiment, too, a displacement of the heating line 13 may be enabled when it is inserted into the fluid chamber 2. In addition, a three-dimensional displacement can be achieved. The arrangement of channel 21 described in FIG. 10 can be advantageous for fluid ports 3, 4, which are arranged radially to axis 12 but not collinear to each other.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “—” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A heatable fluid chamber assembly for a window or headlight washer system of a vehicle, said assembly comprising:
a fluid chamber having a first fluid port;
a heating line arranged in the fluid chamber, and optionally arranged in the first fluid port; and
a rotary disk arranged rotatably about an axis in or on the fluid chamber and having a deflector extending into the fluid chamber;
wherein a portion of the heating line is displaceable by the deflector during a rotation of the rotary disc; and
wherein the first fluid port extends radially to the axis.

2. The assembly according to claim 1, wherein a second fluid port is provided on the fluid chamber and optionally extending radially to the axis and/or collinearly to the first fluid port.

3. The assembly according to claim 2, wherein the heating line runs through the second fluid port.

4. The assembly according to claim 2, wherein the deflector in a first rotary position of the rotary disk allows for a straight-lined run of the heating line from the first fluid port to the second fluid port and through the fluid chamber.

5. The assembly according to claim 1, wherein a nozzle unit and/or a check valve is provided in the fluid chamber.

6. The assembly according to claim 1, wherein the rotary disk has a second deflector extending into the fluid chamber and optionally arranged off-centered with respect to the axis at the rotary disk.

7. The assembly according to claim 5, wherein in a second rotary position, the deflector is arranged in the area of the nozzle unit or of the check valve.

8. The assembly according to claim 1, wherein the deflector is configured to wind up the heating line.

9. A method of manufacturing a heatable fluid chamber assembly for a window or headlight washer system of a vehicle, said method comprising:
providing a fluid chamber having a first fluid port;
passing a heating line through the first fluid port into the fluid chamber; and
rotating a rotary disk which is arranged rotatably about an axis in or on the fluid chamber thereby deflecting a portion of the heating line.

10. The method according to claim 9, comprising passing the heating line through the fluid chamber and a second fluid port.

11. The method according to claim 9, comprising deflecting the portion of the heating line towards a nozzle unit provided inside the fluid chamber and/or towards a check valve provided inside the fluid chamber.

12. The method according to claim 9, wherein by rotation of the rotary disk, a deflector arranged at the rotary disk engages the heating line.

13. The method according to claim 9, wherein by rotation of the rotary disk, deflectors arranged at the rotary disk engage the heating line, optionally from two opposing sides of the heating line.

14. The method according to claim 9, comprising rotating the rotary disk by an angle exceeding 45 degrees, optionally exceeding 90 degrees, or optionally exceeding 180 degrees.

15. The method according to claim 14, comprising winding the heating line about the deflector.

16. The assembly according to claim 1, wherein the heating line is arranged in the fluid chamber and in the first fluid port.

17. The assembly according to claim 2, wherein the second fluid port is provided on the fluid chamber and extends radially to the axis and/or collinearly to the first fluid port.

18. The assembly according to claim 6, wherein the second deflector extends into the fluid chamber and is arranged off-centered with respect to the axis at the rotary disk.
